(19) United States
(12) Patent Application Publication
(10) Pub. No.: US 2026/0295638 A1
(43) Pub. Date: Oct. 1, 2026

(54) SORTING SYSTEM ON SHIP IN TRANSIT DURING SUPPLY CHAIN IDLE TIME

(71) Applicant: TARGET BRANDS, INC., Minneapolis, MN (US)

(72) Inventor: Deeksha Shivakumar Kumar, San Jose, CA (US)

(21) Appl. No.: 19/091,272

(22) Filed: Mar. 26, 2025

(51) Int. Cl. B07C 3/02; B63B 69/00; B65G 1/137

(52) U.S. Cl. CPC B07C 3/02; B63B 69/00; B65G 1/137

(57) ABSTRACT

Disclosed herein are techniques for in-transit inventory sortation. For example, a ship can include a storage area to maintain a first group of containers having unsorted inventory, a sortation area to maintain a second group of containers having sorted inventory, a container movement system to move, while the ship is in transit, the unsorted inventory from the storage area to the sortation area, and a sortation system to sort, while the ship is in transit, the unsorted inventory based on one or more sorting criteria and move the sorted inventory into the second group of containers that satisfy the one or more sorting criteria. The ship can sometimes include automated conveyors to move the inventory in the ship based on the sorting performed by the sortation system.

### TECHNICAL FIELD

This disclosure generally describes devices, systems, and methods related to utilizing and adapting a freight carrier, such as a ship or container ship, with a sorting system to sort inventory according to their final destinations while the freight carrier is in transit.

### BACKGROUND

Global commerce is expanding rapidly. Millions of products can arrive and depart daily from ports to address the increases in global commerce. Container ships can take anywhere from 15 to 30 days to reach ports in a supply chain, which can further depend on origin of shipment and destination port. The products may also remain at a port for several days thereafter for inspection.

During a transportation period, products remain idle and unworked in the ships. Once the products arrive at a port, they may still need to be transported to facilities, such as deconsolidator facilities and/or distribution centers, sorted by product type, final destination (e.g., customer or store), and/or appropriate storage locations all to facilitate distribution. Existing downtime creates bottlenecks in the supply chain, delaying order fulfillment and reducing efficiency.

### SUMMARY

The disclosure generally describes technology for enhancing an order fulfillment process by utilizing idle time in transit of ships, such as container ships or similar freight carriers. This disclosed technology can improve efficiency by sorting products (e.g., inventory) according to their final destination (e.g., to customers or for store replenishment) and/or type during the transportation period. For example, a ship can be adapted with a manual, semi-automated, and/or an automated sorting system, which can be configured to sort, sequence, and slot products and/or cartons of products (e.g., inventory) into containers according to their final destinations while the ship is in transit. Additionally, the disclosed technology includes techniques for determining how to move containers around a ship while the ship is in transit and determining when the containers can be sorted based on the ship's movement, weather conditions, and/or other factors. Such techniques can require planning moves when there is limited workspace in the ship.

In a semi-automated onboard sorting system, containers can be opened onboard the ship during its journey and products (e.g., inventory, cartons of products) therein can be sorted manually and/or semi-automatically into new containers based on their final destination and/or type. The re-sorted products can be routed/conveyed into new destination-specific containers. Upon arrival at a port, the containers are already pre-sorted and ready for direct transportation to the respective final destination(s). Advantageously, this approach can result in minimal changes to current shipping infrastructure and provide simple and easy implementation.

In a fully automated onboard sorting system, an automated sorting system can be used onboard the ship. Products (e.g., inventory) can be loaded onto the ship using high-speed conveyors, or other automated conveyor systems, and placed into an intelligent, automated sorter. During the trip, the automated sorting system can implement algorithms to sequence, slot, and sort the products based on their destination and/or type and while balancing the ship's load distribution and other external factors (e.g., ship movement, weather conditions). Upon arrival at a destination port, the sorted products can leave the ship in sequence via automated conveyors and can be directly loaded onto trailers, containers, or other freight carriers destined for stores, warehouses, or other final destinations. The disclosed system can advantageously eliminate manual sorting, speed up an unloading process to enable faster delivery to destinations, optimize space and weight distribution across the ship for safety and efficiency, and allow for direct integration with port and warehouse operations.

One or more embodiments described herein can include a ship that can be configured for in-transit inventory sortation, the ship including: a storage area that can be configured to maintain a first group of containers having unsorted inventory, a sortation area that can be configured to maintain a second group of containers having sorted inventory, a container movement system that can be configured to move, while the ship is in transit, the unsorted inventory from the storage area to the sortation area, and a sortation system that can be configured to sort, while the ship is in transit, the unsorted inventory based on one or more sorting criteria and move the sorted inventory into the second plurality of containers that may satisfy the one or more sorting criteria.

In some implementations, the embodiments described herein can optionally include one or more of the following features. For example, the second group of containers can each be designated for a final destination. The one or more sorting criteria can include a final destination of the sorted inventory. The one or more sorting criteria can include a product type of the sorted inventory. The container movement system can be configured to move a portion of the unsorted inventory from the first group of containers to the sortation area based on the portion of the unsorted inventory satisfying the one or more sorting criteria. Sometimes, the ship further may include a propulsion system that can be configured to power the container movement system and the sortation system while the ship is in transit. The container movement system can include automated or semi-automated conveyors. The container movement system can include a fleet of robots or automated machines.

One or more embodiments described herein can include a ship that can be configured for automated in-transit inventory sortation, the ship including: a storage area that can be configured to maintain inventory, a sortation system that can be configured to sort, while the ship is in transit, the inventory based on one or more sorting criteria and move the sorted inventory into storage locations in the storage area that satisfy the one or more sorting criteria, and automated conveyors that can be configured to move the inventory in the ship based on the sorting performed by the sortation system.

The ship can optionally include one or more of the abovementioned features and/or one or more of the following features. For example, the ship can include an inventory retention system that can be configured to automatically adjust to a size of each of the inventory to securely maintain each of the inventory in place while the ship is moving or while each of the inventory is moving in the ship. The automated conveyors can include high-speed conveyors. The ship can include an automated ingress/egress system that can be configured to move the inventory from containers at a port into the storage area of the ship before the ship leaves the port. Sometimes, the ship can include a control system that can be configured to: control automated machines to automatically load the inventory onto the ship at a port, control the automated machines to automatically move the inventory to the sortation system onboard the ship, identify common destinations for the inventory based on a manifest for the inventory, determine sorting operations for sorting the inventory, by the sortation system, based on the common destinations for the inventory, and execute instructions to cause the sortation system to perform the sorting operations while the ship is in transit. Determining the sorting operations can be further based on balancing a load of the ship while the ship is in transit. Determining the sorting operations can sometimes include: determining picking operations of the inventory, determining packing operations of the inventory, and generating instructions to adjust an inventory retention system based on a size of the inventory being picked and packed.

One or more embodiments described herein can include a system for inventory sortation on a ship in transit, the system including: a storage area that can be configured to maintain inventory, a sortation system that can be configured to sort, while the ship is in transit, the inventory based on one or more sorting criteria, and conveyors that can be configured to move the inventory in the ship based on the sorting performed by the sortation system.

The system can optionally include one or more of the abovementioned features and/or one or more of the following features. For example, the one or more sorting criteria can include final destinations of the inventory, and the storage locations comprise containers that may be designated for the final destinations of the inventory. The storage locations can include locations in the storage area that may be designated for final destinations of the inventory. The sortation system can include automated machines. The system further may include a control system that can be configured to, while the ship is in transit: receive a manifest for the inventory onboard the ship, determine common destinations for the inventory based on the manifest, determine sorting operations, for execution by the sortation system, to sort the inventory based on the common destinations, and return the sorting operations for automatic execution by the sortation system.

The devices, system, and techniques described herein may provide one or more of the following advantages. For example, conventional systems require loading products onto a ship and sorting the products once the ship docks at a destination port. As a result, delivery of the sorted products can be delayed, increasing the inefficiencies in the supply chain. The disclosed technology provides improvements to the conventional systems by incorporating an automated and/or semi-automated sorting system onto ships to perform sortation techniques during supply chain idle time whilst the ship is in transit. As a result, the sortation process can be automated and performed during idle time such that when the ship arrives at the destination port, the sorted products may be unloaded and transported to final destinations without spending additional time sorting the products at the port.

Accordingly, automating a sorting and classification process while products are en route in a ship can reduce manual steps in such processes, eliminate downtime, and enhance timely delivery of high-demand products. Automation herein can also reduce human error, improve accuracy, and streamline an entire fulfillment process, from port arrival to final delivery. As a result, transportation time (e.g., idle periods during shipment) can be maximized and turned into productive time to improve order fulfillment efficiency in the supply chain. By sorting products during a shipping process, the disclosed technology can meet rising commerce demands while ensuring timely delivery and minimizing errors in sorting, sequencing, and other supply chain activities. Similarly, high demand and/or trend-sensitive products can be prioritized using the disclosed technology, thereby ensuring that such products reach end users or stores as quickly as possible. The disclosed technology can also reduce post-arrival workload at ports, allowing for faster order processing and minimizing delays. Automating the sorting process as described herein can also reduce or otherwise eliminate human error, leading to a more efficient and reliable system for sorting products.

The disclosed technology can provide one or more additional advantages. For example, the disclosed technology can reduce transportation costs. The disclosed technology can reduce carbon emissions from additional or other traditionally-used transportation modes (e.g., trucks, trains, planes). The carbon emissions can also be reduced since the disclosed technology reduces or otherwise eliminates transport of cartons/packages of items or products to different buildings throughout a supply chain (e.g., deconsolidator buildings, distribution centers, sortation centers). Moreover, fully automated techniques described herein can reduce quantities of workers needed to sort products for final destinations, thereby resulting in cost savings across the supply chain.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for sorting inventory on a ship in transit.

FIG. 2 is a conceptual diagram of a system for sorting inventory upon arrival at a destination port versus sorting inventory on a ship in transit and before arrival at the destination port.

FIG. 3 is a conceptual diagram of a semi-automated system for sorting inventory on a ship in transit.

FIG. 4 is a conceptual diagram of an automated system for sorting inventory on a ship in transit.

FIG. 5 is an illustrative example of an inventory retention system on a ship in transit.

FIG. 6 is a conceptual diagram of a system for sorting inventory in transit.

FIG. 7 is a flowchart of a process for semi-automatically sorting inventory onboard a ship in transit.

FIG. 8 is a flowchart of a process for automatically sorting inventory onboard a ship in transit.

FIG. 9 is a flowchart illustrating a flow of inventory and a flow of information using the disclosed techniques.

FIG. 10 is a system diagram illustrating components that can be used to perform the disclosed techniques.

FIG. 11 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to technology for sorting inventory (e.g., products) according to their final destination (e.g., customers, store replenishment) and/or type onboard a ship (e.g., container ship, freight carrier) in transit.

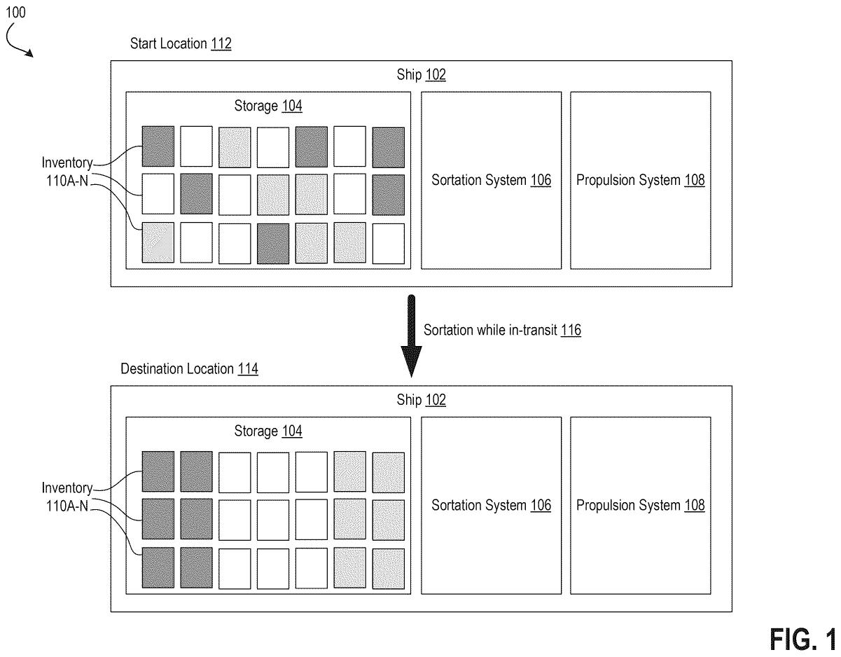

Referring to the figures, FIG. 1 is a conceptual diagram of a system 100 for sorting inventory on a ship 102 in transit. The ship 102 can include, among other features, components, and/or equipment, a storage 104, a sortation system 106, and/or a propulsion system 108.

In brief, the storage 104 can be an area onboard the ship 102 for maintaining inventory 110A-N (e.g., products). The storage 104 can include containers. In some implementations, the storage 104 can be containers that maintain the inventory 110A-N. Sometimes, the inventory 110A-N can be containers of products that are maintained in the storage 104 of the ship 102 while the ship 102 is in transit.

The sortation system 106 can include any combination of components, automated machines, and/or systems described herein that can be configured to perform sortation techniques onboard the ship 102. For example, the sortation system 106 can include one or more conveyors (e.g., high-speed, automated, semi-automated), sorters, robots, automated machines for moving the inventory 110A-N, and/or a computing system configured to determine and execute sortation instructions.

The propulsion system 108 can be configured to power components of the sortation system 106. For example, the propulsion system 108 can provide energy to the sortation system 106 components. The propulsion system 108 can include but is not limited to diesel engines, gas turbines, hybrid systems of traditional engines and electric motors, generators, batteries, battery banks, power distribution boards, energy storage systems, and/or power management systems. The propulsion system 108 can, via the power distribution board, be configured to provide or otherwise route energy/power to the components of the sortation system 106 that operate to perform the sortation techniques onboard the ship 102.

In the example system 100, at a start location 112 (e.g., a loading dock/port), the ship can be loaded with the inventory 110A-N in the storage 104. As shown via different indicia (e.g., different coloring), the inventory 110A-N may not be sorted in the storage 104. Some of the inventory 110A-N, demarcated by the darkest color/shading, may not be arranged next to or with other inventory 110A-N having the same darkest color/shading. Thus, the inventory 110A-N demarcated by the darkest color/shading can be placed in the store 104 next to or in a same region as the inventory 110A-N with the lightest color/shading (e.g., white shading) and/or the inventory 110A-N with a light color/shading (e.g., light grey shading).

Sortation techniques can be performed, by the sortation system 106, while in transit (116), as described further herein. The inventory 110A-N represented by the different color/shading can therefore be sorted according to final destination and/or type information. For example, all of the inventory 110A-N having the darkest color/shading may be associated with a same final destination, and thus sorted and grouped together in the storage 104 whilst in transit. Likewise, all of the inventory 110A-N having the lightest color/shading may be associated with a same final destination, and thus sorted and grouped together in the storage 104. All of the inventory 110A-N having the light color/shading may be associated with a same final destination, and thus sorted and grouped together in the storage 104.

Upon arrival at a destination location 114, the inventory 110A-N may already be sorted according to their final destination and/or type (as shown by all the inventory 110A-N of the darkest color/shading grouped together, all the inventory 110A-N of the lightest color/shading grouped together, and all the inventory 110A-N of the light color/shading grouped together. As a result, the sorted inventory 110A-N can be unloaded from the ship 102 and transmitted directly to their final destinations without first being unloaded and then sorted at the port, dock, or in a nearby distribution center or other similar facility. Such techniques can therefore reduce overall lag time in delivering the inventory 110A-N to final destinations and improve efficiencies in the supply chain.

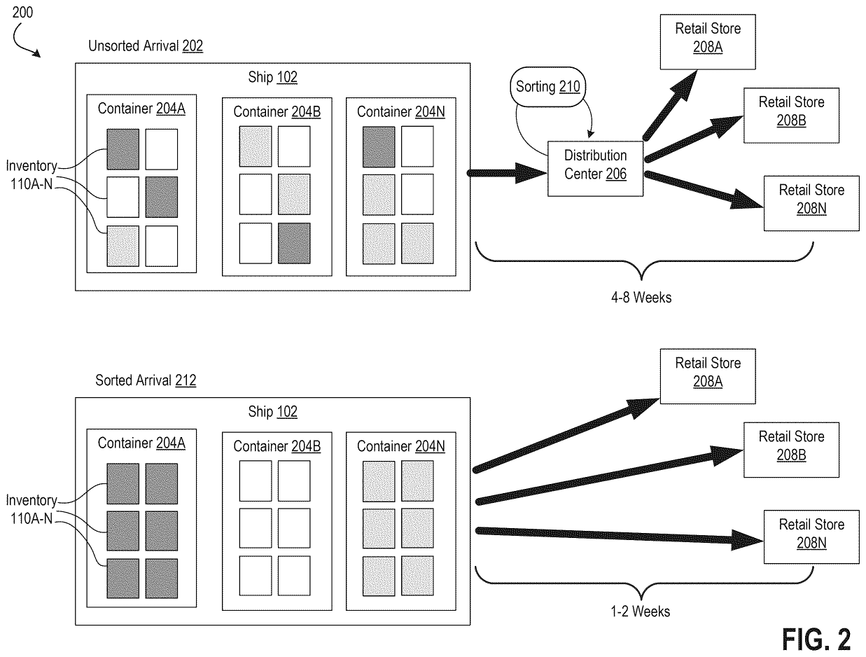

FIG. 2 is a conceptual diagram of a system 200 for sorting inventory 110A-N upon arrival (202) at a destination port versus sorting inventory 110A-N on a ship 102 in transit (212) and before arrival at the destination port.

In the example of the unsorted arrival (202), the ship 102 can arrive (e.g., at a destination port) with the inventory 110A-N unsorted in containers 204A-N. As a result, inventory 110A-N having different final destinations and/or types may not be sorted accordingly. Upon arrival, the containers 204A-N can be unloaded from the ship 102 and brought to a distribution center 206 or similar facility where sorting of the inventory 110A-N can occur (210). Once the inventory 110A-N is sorted at the distribution center 206, the sorted inventory 110A-N can be transported to respective retail stores 208A-N or other final destinations (e.g., other distribution centers, warehouses, and/or directly to end users/customers). This entire process of sorting and transport to final destinations can take an extensive amount of time, such as but not limited to 4-8 weeks.

In the example of the sorted arrival (212), on the other hand, the ship 102 can arrive with the inventory 110A-N sorted in the containers 204A-N. As described herein, the containers 204A-N can be identified and designated for different final destinations and/or inventory/product types. Whilst in transit, the inventory 110A-N can then be manually, semi-automatically, or automatically sorted into the appropriate containers 204A-N based on the respective final destinations and/or inventory/product types. As a result, upon arrival, the sorted containers 204A-N can be unloaded from the ship 102 and automatically routed to the respective final destinations, such as the retail stores 208A-N. This entire process can take significantly less time than the scenario for unsorted arrival (202). As a merely illustrative example, the process for sorting and transporting the inventory 110A-N in the sorted arrival scenario (212) can take approximately 1-2 weeks, in comparison to the longer amount of time in the unsorted arrival scenario (202).

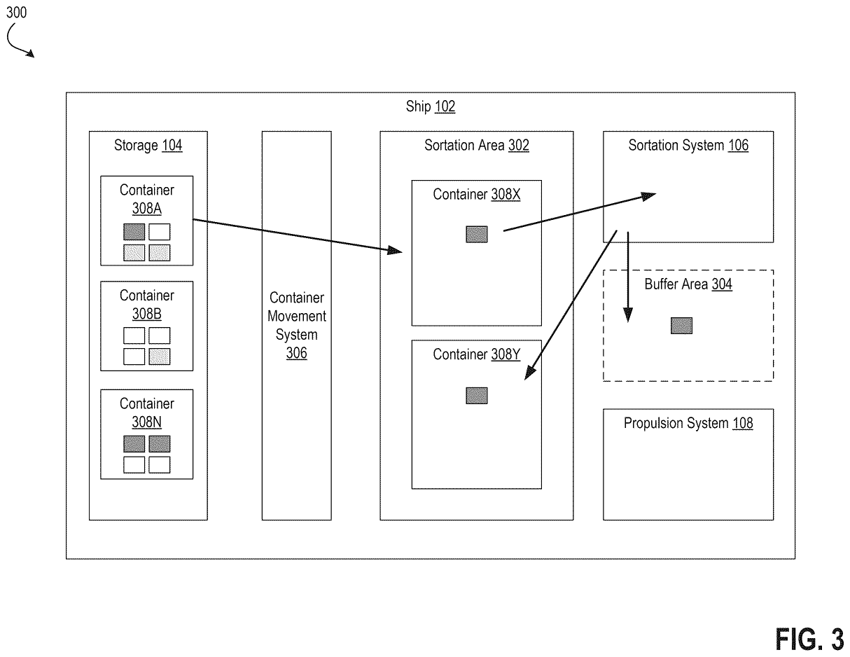

FIG. 3 is a conceptual diagram of a semi-automated system 300 for sorting inventory on a ship 102 in transit. In this system 300, the inventory can be sorted manually and/or semi-automatically. The inventory can include products or items that are palletized in containers, packages or products that are free in the containers, packages or products that are in cases and/or boxes, and/or cases on pallets of similar type of products. The system 300 provides for reorganizing assets, components, and/or resources on the ship 102 to allow for moving containers to and from different areas (e.g., moving containers from a storage area to a sortation area).

The ship 102 in the system 300 can include at least the storage 104, a sortation area 302, a container movement system 306, the sortation system 106, an optional buffer area 304, and the propulsion system 108.

The storage 104 can be configured to maintain containers 308A-N having mixed inventory, meaning inventory that was loaded (in the containers 308A-N) onto the ship 102 without first being sorted. Therefore, each of the containers 308A-N can maintain combinations of inventory intended for different final destinations and/or types. The containers 308A-N can be loaded onto the ship 102 using cranes (not depicted). Sometimes, the containers 308A-N can be stacked on top of each other in height in the storage 104. While the ship 102 is in transit, the stacked containers 308A-N may also be moved around to perform the disclosed techniques. The containers 308A-N can be stacked and unstacked aboard the ship 102 using cranes and/or other lift systems (e.g., automated lift systems, elevators) that can execute instructions to automatically lift and/or move the containers 308A-N.

The sortation area 302 can be an area of the ship 102 that is designated and/or set aside for a sortation process to be performed. In some implementations, the sortation area 302 can include or otherwise be a part of the storage 104. Sometimes the sortation area 302 can be the same as the storage 104. The sortation area 302 can be apart from or distance from the storage 104 on the ship. Thus, the container movement system 306 can be configured to route inventory from the containers 308A-N in the storage 104 to the sortation area 302. In some implementations, the sortation area 302 can be proximate or otherwise near the storage 104 to reduce travel time and increase efficiencies in the sortation process. The size and/or location of the sortation area 302 relative other components or areas in the ship 102 can also depend and be dynamically adjusted based on the size of the ship 102, the availability of space on the ship 102, the use of space on the ship 102, load balancing of the ship 102, weight of sortation equipment aboard the ship 102, proximity to the propulsion system 108 for power/electricity to be provided to the sortation equipment described herein, and/or any combination thereof. As an illustrative example, a computer system described herein can be configured to receive information about the ship 102 and its components and compare and balance the information using optimization algorithms to determine a preferred or optimal size and location of the sortation area 302. The computer system may determine that the sortation area 302 ought to be as close as possible to the propulsion system 108 to allow for consistent and quick delivery of power to the sortation equipment, but the computer system may determine that the sortation area 302 should be less than a threshold size because any larger than the threshold size can cause the load across the ship 102 to become unbalanced. Sometimes, the computer system may determine to shift one or more of the containers 308A-N to another side of the ship 102 where the sortation area 302 may not be located, even if it means transporting products a greater distance to the sortation area 302, in order to ensure that the load of the ship 102 remains balanced. One or more other considerations can be made by the computer system. The sortation area 302 can be configured to maintain containers 308X-Y, which can be designated as final destination (and/or type) containers.

The container movement system 306 can be configured to move inventory to and from any of the components that are part of the ship 102. The system 306 can include but is not limited to conveyors, one or more robots, a fleet of robots, automated machines, semi-automated conveyors, fully automated conveyors, and/or high-speed conveyors. The system 306 can also be configured to move some of the containers 308A-N, in some implementations, from the storage 104 to the sortation area 302 so that the moved containers 308A-N can be designated as the destination containers 308X-Y.

The sortation system 106 can be configured to move the inventory described herein to, from, between, and amongst the components of the ship 102. The sortation system 106 can also execute instructions to cause the inventory to sorted, sequenced, slotted, and/or loaded into the containers 308X-Y in particular orders.

The buffer area 304 can be optionally included as part of the ship 102. For example, a portion of the ship 102 can be designated as the buffer area 304 based on availability of space on the ship 102 to allocate for the buffer area 304. The buffer area 304 can be configured to receive and temporarily maintain inventory that is being moved from the containers 308A-N in the storage 104 to the designated containers 308X-Y in the sortation area 302.

The propulsion system 108 can power the components of the ship 102 to perform the techniques described herein.

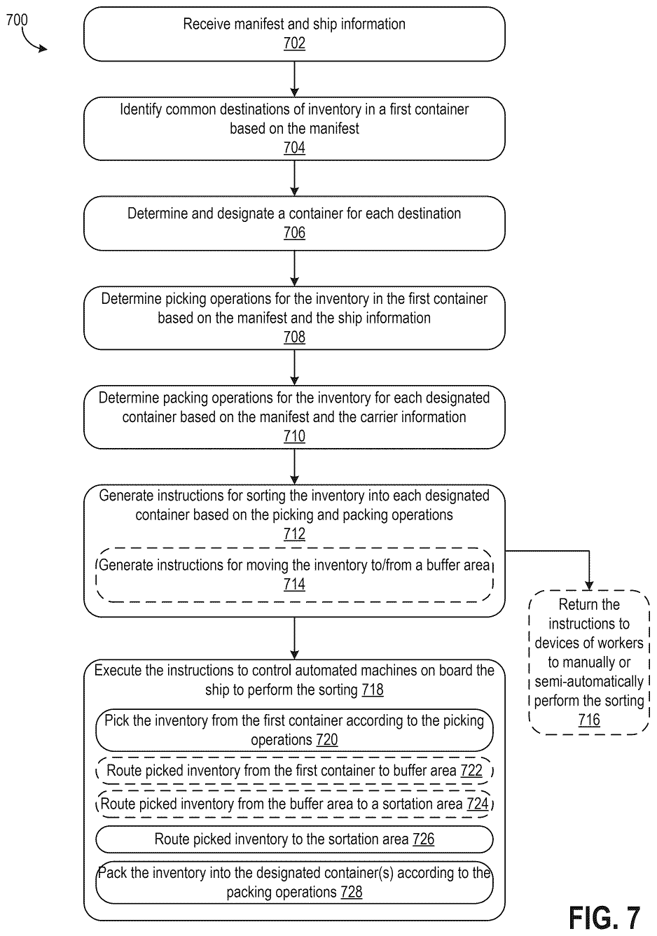

In an illustrative example of the system 300 in FIG. 3, a manifest can be received for inventory onboard the ship 102. The manifest can indicate information such as final destinations, customers, and/or item types for each of the inventory that's maintained in the containers 308A-N of the storage 104. Using the manifest as an input, described further in reference to FIG. 7, a determination can be made (e.g., by one or more computing systems) about where to move the inventory from the containers 308A-N according to at least their final destinations. The computing system(s) can determine common destinations across the inventory (e.g., individual stores, distribution centers, or other geographic destinations). Additionally or alternatively, computer systems having the manifest can also predetermine how the containers 308A-N can initially be placed onto the ship 102 (in the storage 104) during loading for easy access to be sorted later on while the ship 102 is in transit. In some implementations, the predetermination can be provided to the computer system(s) that can perform the disclosed techniques to determine optimal placements of the containers 308A-N. For example, the computer system(s) can modify the predetermined locations of the containers 308A-N.

For example, the computing system(s) can determine that all inventory in the containers 308A-N that are intended for a first final destination be assigned to and sorted in the container 308X in the sortation area 302. In such an example, the container movement system 306 can be instructed and controlled to route the inventory associated with the first final destination from the containers 308A-N to the container 308X in the sortation area 302. The container movement system 306 can include high-speed conveyors and/or cranes, which can be configured to route and/or reroute the inventory to different destination conveyors and/or destination containers 308X-Y.

The sortation system 106 can be configured to then sort all the inventory in the container 308X according to one or more factors, including but not limited to final destination, type of product/inventory, weight and/or sizing characteristics of the inventory, where the inventory would be placed in a store/distribution center, etc. For example, the sortation system 106 can sort the inventory in the sortation area 302 then load the sorted inventory onto the container 308X. The containers 308A and 308N can be craned to the sortation area 302 and sorted there using the sortation system 106. Then the sorted inventory can be loaded onto a new container that is carried on the ship as an empty container. The new container that's been loaded with the sorted inventory can then be moved to the storage 104. In some implementations, once either of the containers 308A or 308N is emptied in the sortation area 302, the emptied container 308A or 308N can be loaded with the sorted inventory (and therefore become the sorted container 308X described above). Then the container 308X can be put away in the storage 104.

As another example, the sortation system 106 can sort the inventory inside of the container 308X. In yet some implementations, the sortation system 106 can be configured to sort the inventory in the sortation area 302 and sometimes move one or more of the inventory to the buffer area 304 (e.g., if the one or more of the inventory is occupying space in the sortation area 302 and/or the container 308X that otherwise should be occupied by other inventory; if the one or more of the inventory is intended to be inside the container 308X, has been moved to the sortation area 302, but should be loaded last into the container 308X). The techniques described herein can be performed for all the inventory in the storage 104 during the duration of the ship 102's trip.

As another example, the computing system(s) can determine that one of the containers 308A-N should be designated as a final destination container. Accordingly, the computing system(s) can control components of the ship 102 (e.g., the container movement system 306 and/or the sortation system 106) to unload the inventory from the container that was identified as a final destination container, move that unloaded inventory to the buffer area 304, redesignate the unloaded container as the final destination container, and then load the final destination container with inventory from one or more of the other containers 308A-N having the same final destination. Sometimes, the unloaded inventory can be moved directly to another one of the containers 308X-Y that has been designated for final destinations. As a result, inventory and/or containers can be shuffled around on the ship 102 whilst the ship 102 is in transit to ensure that the inventory is sorted according to their final destination before the ship 102 arrives at a destination port.

As yet another example, the computing system(s) can determine and execute instructions to cause the components of the ship 102 to empty one of the containers 308A-N by moving all of its inventory to the buffer area 304, then designate the empty container as a final destination container. Sometimes, multiple containers 308X-Y can be designated as final destination containers and sorted at the same time. In some implementations, the final destination containers can be sorted independently of each other and in series. Sometimes, the computing system(s) can determine and execute instructions to cause the components of the ship 102 to divide the inventory (e.g., inventory having the same product type) into multiple final destination containers, such that some of the same inventory goes to one destination and the remaining of the same inventory goes to another destination. The multiple destinations can, as an illustrative example, be distribution centers, retail stores, customer addresses, or any other locations associated with the inventory.

In some implementations, a user working on the ship 102 can be tasked with packing the inventory onto the containers 308X-Y in the sortation area 302. When the user picks the inventory, they can scan, using a scanning device (e.g., camera, barcode reader, infrared device, imaging device, LiDAR device), a label or other identifying information on the inventory (e.g., a barcode, QR code). The scanned label can be transmitted to the computing system(s) described further herein and used by the computing system(s) to track movement and location of the inventory whilst the ship 102 is in transit. The label or other identifying information on the inventory can be scanned, manually or automatically, at multiple different checkpoints on the ship 102 to track the movement and the location of the inventory. For example, the label on the inventory can be scanned when the inventory is loaded onto the ship 102. The label can be scanned again when the inventory is loaded onto the container movement system 306 to be routed from one of the containers 308A-N in the storage 104 to one of the containers 308X-Y in the sortation area 302 and/or to/from the buffer area 304. The label can be scanned once the inventory arrives in the sortation area 302, once the sortation process begins with the sortation system 106, and/or once the sortation process ends by the inventory being loaded into its designated one of the containers 308X-Y. The scans described here can also be used to determine other/additional information about the inventory, including but not limited to size, final destination, weight, potential damage, etc.

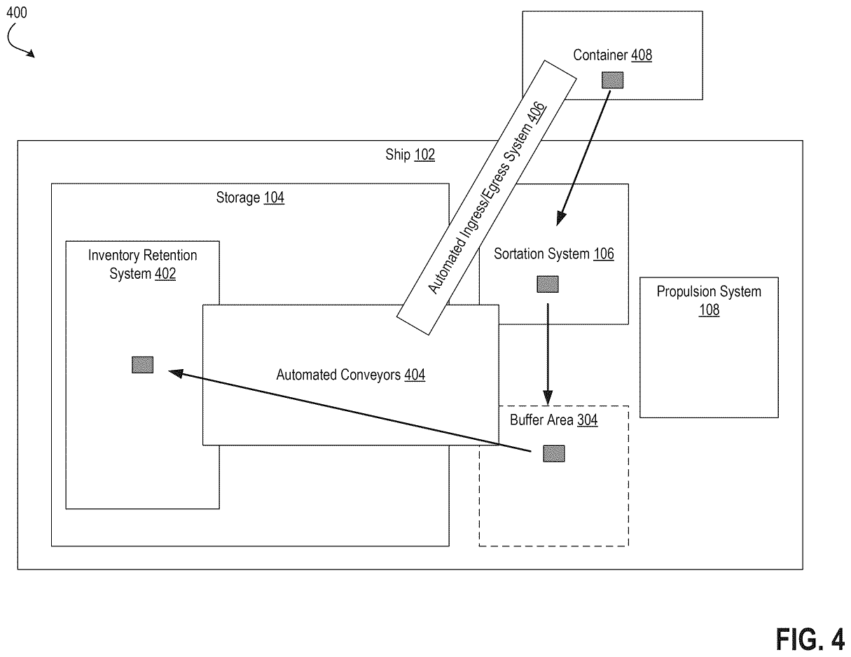

FIG. 4 is a conceptual diagram of an automated system 400 for sorting inventory on a ship 102 in transit. The system 400 can allow for inventory to be sequenced and sorted automatically whilst balancing load and other characteristics associated with the ship 102. Such sequencing and sorting can occur whilst the ship 102 is in transit. As a result, upon arrival at a dock/destination port, the inventory arrives pre-sequenced, based on final destination, product type, and/or other customer/related user requirements and/or constraints. Then, the inventory can be unloaded at the dock port accordingly and transported to their final destinations. Accordingly, the system 400 may not require containers on board the ship 102, as described herein. Since containers will not be loaded onto the ship 102 nor sorted on the ship 102 according to final destinations, the system 400 may not require the use of cranes or similar equipment at ports. This configuration can advantageously reduce total time for moving inventory through the supply chain to their final destinations, thereby improving efficiencies in the overall supply chain.

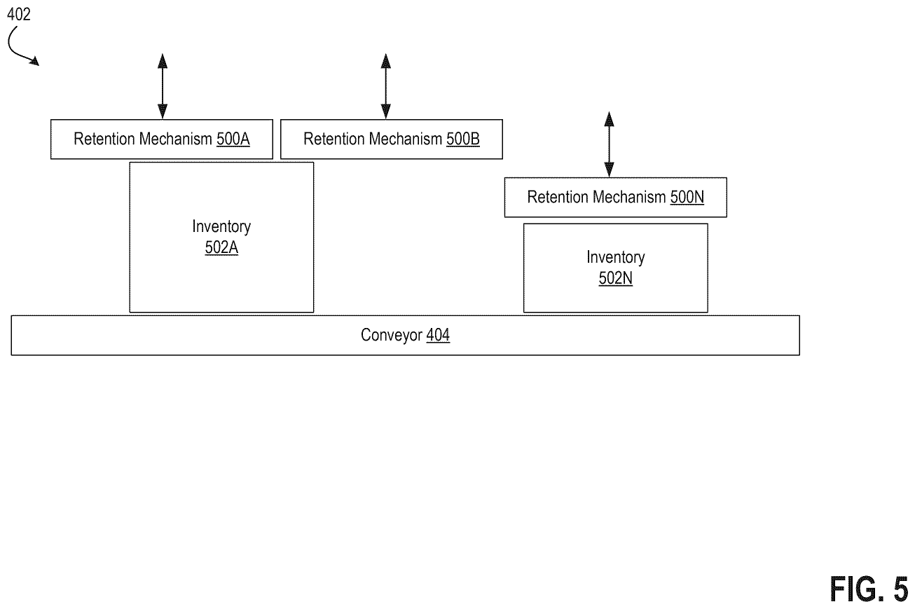

In the example system 400, the ship 102 can include the storage 104, the sortation system 106, the propulsion system 108, the optional buffer area 304, an inventory retention system 402, automated conveyors 404, and/or an automated ingress/egress system 406. In brief, the inventory retention system 402 can be configured to maintain the inventory in place as it is moved via the automated conveyors 404 on the ship 102. The system 402 can include individual locations for which to receive the inventory as it is routed across the automated conveyors 404. As another example, the system 402 can include racks that may securely hold the inventory whilst they are in the storage 104 and/or being moved around the ship 102. Refer to FIG. 5 for further discussion about the system 402. The automated conveyors 404 can include logic to automatically route the inventory to and from different locations in the storage 104 (e.g., to containers such as container 408) for sortation based on final destination. In some implementations, the automated conveyors 404 can be part of or otherwise include automated storage and retrieval systems including cranes, miniloads, shuttle systems, vertical lift modules, vertical carousels, horizontal carousels, robots, AGVs, and/or autonomous mobile robots (AMRs). The automated conveyors 404 can also be lined up with the automated ingress/egress system 406 and/or other conveyors that may be part of a dock at a port. The automated ingress/egress system 406 can be configured to route the inventory to and from the ship 102 to components external the ship 102, such as the container 408 at a destination or departure dock/port. The automated ingress/egress system 406 can include conveyors, such as high-speed conveyors and/or automated conveyors. In some implementations, the system 406 can be part of or the same as the automated conveyors 404.

In the illustrative system 400, the ship 102's sortation system 106 may not require containers on board the ship 102. In other words, the ship 102 can be built and/or retrofitted to provide for the sorting and sequencing of the inventory directly in the storage 104 using the inventory retention system 402, without having to move the inventory to and from containers on the ship 102. The sortation system 106 can include a plurality or group of automated sorters, which can be configured to execute logic that causes the system 106 to automatically sequence the inventory in a preferred order based on final destinations in the storage 104.

As an example of implementing the system 400, the container 408 can arrive at the dock/port. Inventory from the container can be removed from the container 408 and loaded (e.g., automatically, manually) onto the automated ingress/egress system 406. While the inventory is loaded onto the system 406, one or more labels or other identifying information associated with the inventory can be scanned, as described herein. Once the inventory is brought into the ship 102, it can be routed (e.g., via the automated conveyors 404) to the sortation system 106, which can be configured to automatically sequence and/or sort the inventory according to at least their final destinations. Once the inventory is sequenced and sorted, it can be routed, via the automated conveyors 404, to the inventory retention system 402 in the storage 104 until the ship 102 docks at the destination port. Along any portion of the described operations, the inventory can be automatically (and/or manually) scanned to provide tracking information and other relevant information about the movement and location of the inventory on the ship 102.

Upon arrival at the destination port, the inventory in the inventory retention system 402 can be unloaded and automatically routed along the automated conveyors 404, to the automated ingress/egress system 406, and into one or more containers at the port that are designated for final destinations. The inventory being unloaded from the ship 102 can be unloaded based on their sequencing and sorting, thereby making it efficient and quick to route the inventory to their final destination containers at the port.

FIG. 5 is an illustrative example of an inventory retention system 402 on a ship in transit. The system 402 can include adjustable retention mechanisms 500A-N. The retention mechanisms 500A-N can include bars or other structures/features that may automatically adjust in height based on a size/height of inventory 502A-N.

As an illustrative example, when the inventory 502A-N is loaded onto the automated conveyors 404, the retention mechanisms 500A-N can be automatically controlled (e.g., by the computing system(s) described herein) to lower to a height that is proximate a maximum height of each of the inventory 502A-N. Sometimes, the retention mechanisms 500A-N may be lowered to be flush with a top or maximum height of the inventory 502A-N. Sometimes, the retention mechanisms 500A-N may be lowered to be at least a threshold distance above the top or the maximum height of the inventory 502A-N to allow for some flexibility/movement as the inventory 502A-N moves along the conveyors 404. In some implementations, the retention mechanisms 500A-N may be used in the storage 104 of the ship 102 (refer to at least FIG. 4 for further discussion) to securely maintain the inventory 502A-N in their respective sequenced/sorted locations in the storage 104. Sometimes, the retention mechanisms 500A-N can be used to securely maintain the inventory 502A-N on the conveyors 404 as they are automatically routed throughout the ship 102 according to their designated sequencing and/or sorting. This configuration can advantageously ensure that the inventory 502A-N remains on the conveyors 404 and/or in secure storage locations whilst the ship 102 is in transit, regardless of potential weather conditions or other disruptions that can impact a smoothness of the travel journey.

In the example of FIG. 5, the inventory 502A is taller in height than the inventory 502N. As a result, the retention mechanisms 500A and 500B, which span across at least a portion of the length of the inventory 502A can be automatically adjusted according to the height of the inventory 502A. On the other hand, the retention mechanism 500N, which spans across at least a portion of the length of the inventory 502N can be automatically adjusted according to the height of the inventory 502N. To adjust the retention mechanisms 500A-N, the inventory 502A-N can be scanned (e.g., a barcode or label on the inventory 502A-N can be scanned using scanning and/or imaging devices) as they enter a ship via conveyors. Once the inventory 502A-N are loaded onto the conveyors, they can pass through a scan tunnel, which can include a plurality of sensors (e.g., weight, camera, scanners, barcode readers) configured to capture data about the inventory 502A-N for use in determining (by a computer system described herein) measurements (length, width, height) and/or weight of the inventory 502A-N. Such measurements can be used to automatically control the retention mechanisms 500A-N to adjust to an appropriate height for the inventory 502A-N. As an example, the retention mechanisms 500A-N can automatically drop or lower until it touches the inventory 502A-N. The retention mechanisms 500A-N can execute control logic to stop moving once it touches the inventory 502A-N. Sometimes, the retention mechanisms 500A-N can execute control logic to readjust slightly (raise above the inventory 502A-N height by a threshold amount) upon touching the top of the inventory 502A-N. The scan tunnel can also generate information about a destination and/or storage location of the inventory 502A-N, such as based on scanning a barcode or label for the inventory 502A-N. At various turn points and locations along automated conveyors on board the ship, the inventory 502A-N barcode and/or label can be read multiple times to ensure accurate movement of the inventory 502A-N (e.g., left, right, up a level, down a level).

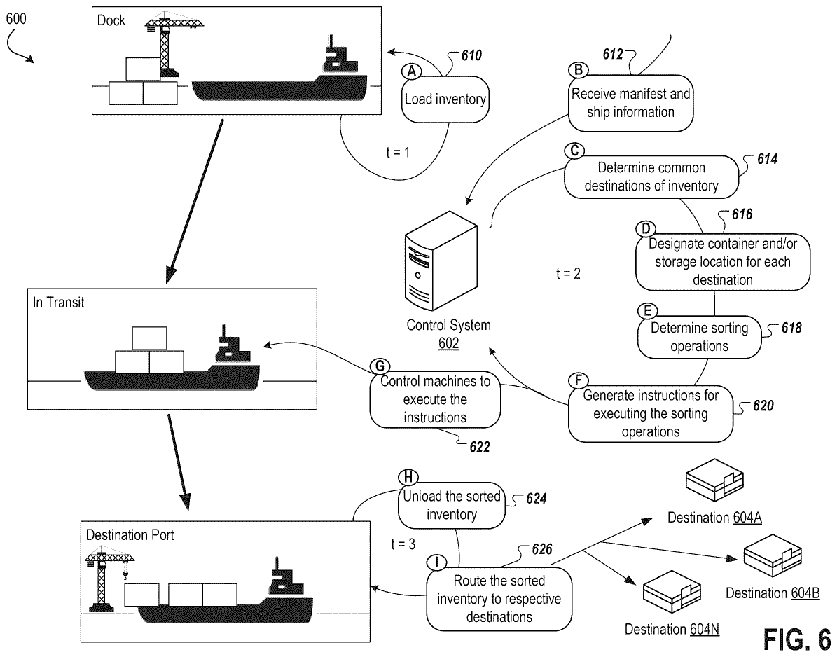

FIG. 6 is a conceptual diagram of a system 600 for sorting inventory in transit. The system 600 can be performed with semi-automated and/or automated approaches described herein.

At time t=1, inventory can be loaded onto the ship at a dock (block A, 610). In the semi-automated implementation, the inventory can be loaded onto the ship in containers. The containers can be loaded thereon using cranes. Sometimes, robots may be used to load the containers onto the ship. In the automated implementation, the inventory can be loaded onto the ship using conveyors, ingress/egress systems, and/or robots. As described herein, the inventory may not be maintained in containers in the automated implementation.

A control system 602 can be configured to receive a manifest and ship information in block B (612). Block B can be performed before or after block A (610). Block B (612) can be performed whilst performing block A (610), as the ship is being loaded with the inventory at the dock. The control system 602 can be a computing system that can be configured to determine sorting and/or sequencing operations for the inventory on the ship whilst in transit. Operations performed by the control system 602 can be performed in real-time and/or before the ship is in transit (e.g., whilst the ship is being loaded with the inventory). Sometimes, the operations can be performed before the ship leaves for the destination port and then can dynamically update the operations based on real-time or current activities in the ship and/or weather conditions.

At time t=2, the control system 602 can determine common destinations of the inventory, based on the manifest (block C, 614). In some implementations, the control system 602 can determine the common destinations of the inventory based on determining whether the inventory satisfies one or more sorting criteria. The one or more sorting criteria can include, but is not limited to, common final destinations, product type, and/or customer requirements. If the control system 602 determines that a portion of the inventory in storage has a common final destination, then the portion of the inventory satisfies the one or more sorting criteria. The control system 602 may then proceed to designate a container and/or storage location based on the one or more sorting criteria (see below, block D, 616). In other words, the control system 602 can designate the container or the storage location for the common final destination of the portion of the inventory.

The control system 602 can then designate containers or storage locations for each common destination (block D, 616). The containers can be designated in the semi-automated implementation. The storage locations can be designated in the automated implementation.

The control system 602 can also determine sorting operations in block E (618). Determining the sorting operations can include balancing load of the ship according to the ship information. The ship information may include, but is not limited to, a load distribution/weight distribution of components and inventory across the ship, weather conditions, travel patterns, travel route, energy/power availability, etc. This information can be processed by the control system 602 (e.g., using rule sets, algorithms, machine learning models, artificial intelligence (AI)) to determine optimal times for performing the sorting operations, optimal orders of sorting operations, etc. Inclement weather, for example, can be a reason to delay or pause sortation operations. Once the weather is identified to be subsiding, the control system 602 can generate instructions to resume the sortation operations and/or perform multiple other operations simultaneously to make up for idle time during the inclement weather.

In an illustrative example of balancing load and determining sorting operations, the sorting operations can be predominantly occurring on one side of the ship or more conveyors can be located on one side of the ship versus the other side. When the loads or cartons of products are being moved and sorted in the thousands, it can cause an imbalance of load on the ship. In regular or moderate weather conditions, that may be okay. However, during severe weather conditions, such an imbalance can negatively affect the ship and cause listing of the ship to one side. Similarly, if more inventory is stored on one side of the ship versus the other, it can cause the ship to list to one side or increase drag, thereby reducing fuel efficiency and increasing strain that leads to structural failure, maneuverability problems, and regulatory violations. The control system 602 can therefore process information as described above through an optimization and/or load balancing algorithm to determine optimal placement of the inventory, sortation equipment, sorting area, and/or operations being performed while the ship is in transit. The control system 602 can dynamically adjust or otherwise modify sorting operations while the ship is in transit, based on information received during transit (e.g., updated weather reports, satellite data, data from external sources and systems).

The control system 602 can then generate instructions for executing/performing the sorting operations (block F, 620), which can be executed to control machines or other systems on the ship (block G, 622). The instructions may include instructing workers and/or automated machines/robots to open boxes or cases, separate out inventory therein, and/or sort the separated inventory according to their final destinations. In some implementations, the instructions may include instructing/controlling robots in a robotic field to retrieve and move inventory to and from different locations on the ship and/or perform other actions with the inventory (e.g., sorting, sequencing, taking apart pallets, building pallets). As a result, the inventory can be sorted and sequenced onboard the ship whilst the ship is in transit. Refer to at least FIGS. 3 and 4 for further discussion about controlling the machines to execute the instructions.

Time t=2 can be the same as time t=1, in some implementations. Sometimes, time t=2 can be before the ship is in transit and/or at the start of the transit. In yet some examples, time t=2 can be during transit of the ship.

At time t=3, the ship can arrive at the destination port. The sorted inventory can be unloaded from the ship (block H, 624). For example, sorted containers can be removed from the ship using cranes in the semi-automated implementation. The sorted inventory can be removed from the ship using conveyors and/or ingress/egress systems in the automated implementation.

The unloaded inventory can then be routed to respective destinations 604A-N (block I, 626). In the semi-automated implementation, the sorted containers can be loaded onto other freight carriers (e.g., trucks) for delivery to the respective final destinations 604A-N. In the automated implementation, the sorted inventory can be loaded onto the other freight carriers for delivery to the respective final destinations 604A-N.

FIG. 7 is a flowchart of a process 700 for semi-automatically sorting inventory onboard a ship in transit. The process 700 can be performed to sort inventory on the ship into containers. The inventory can be sorted into the containers based on one or more characteristics, including but not limited to final destination, product type, and/or customer requirements. In the process 700, containers carrying the inventory can be opened onboard the ship during its journey. Instructions can be generated to cause systems and machines described herein to remove the inventory from the opened containers and sort them into new containers that are designated for specific final destinations, product types, customer requirements, and/or any combination thereof. Advantageously, the semi-automated configuration in the process 700 can allow for minimal changes to be made to a current infrastructure of the ship, thereby making it easy and simple to implement.

The process 700 can be performed by components of the control system 602 that are described in reference to at least FIG. 6. The process 700 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 700 is described from the perspective of a control system.

Referring to the process 700 in FIG. 7, the control system can receive manifest and ship information in block 702. Such information can be received from a computing system at a dock/port of departure. The information can be received from computing systems of relevant stakeholders in the supply chain, such as customers associated with the inventory. The information can be received from warehouse management systems or other data management systems associated with the inventory, the customers, the port, and/or the final destinations of the inventory. In some implementations, the information, such as weather and/or travel-related information, can be received from weather reporting services. The manifest, as described herein, can include information about the inventory onboard the ship, including but not limited to associated customer, storage conditions, size, height, final destination, weight constraints, product type, etc. The ship information can include but is not limited to load information, weight information, weight constraints, available equipment, available power/energy supply to power the equipment, machines, systems, and/or other components onboard the ship, etc. The ship information may also include a map of the ship and/or other information about space, available space, occupied space, etc. of the ship. The ship information can include weather information, travel patterns, travel route, and other aspects of the ship's journey/conditions that may impact the ship's journey.

Sometimes, the control system can be onboard the ship. The control system may also be remote from the ship, e.g., a cloud-based system. The control system can receive the above-identified information in real-time, near real-time, and/or at predetermined time periods (e.g., before the ship leaves the port, while in transit at sea via satellites, nearing a destination port, at the destination port).

In block 704, the control system can identify common destinations of inventory in a first container based on at least the manifest. The control system can process the data/information in the manifest to identify same or similar destinations (e.g., distribution centers, retail stores, end customers). Sometimes, the system can identify destinations that are within a threshold distance from each other and identify those destinations as common destinations. The system can apply one or more trained algorithms, machine learning models, and/or AI to the manifest in order to extract and identify the common destinations. Although the process 700 is described from the perspective of sorting inventory in a first container, the same or similar operations can be performed for other containers onboard the ship carrying inventory to be sorted/sequenced. The process 700 can be performed in parallel for all the other containers or a subset/portion of the other containers. For example, the process 700 can be performed to sort/sequence batches of containers (e.g., containers having items that are generally associated with the same common final destinations). In some implementations, the process 700 can be performed in series, where the process 700 is performed for one container at a time.

The control system can then determine and designate a container for each common destination (or a combination of similar common destinations) in block 706. The control system can first assess the ship information to identify which containers may be empty in the ship, and thus easy to designate as the final destination containers. If there are no empty containers, then the control system may assess the ship information to identify containers that are least full or less than a threshold quantity full. Those identified containers can then be designated as the final destination containers. As yet another example, the system can determine which containers onboard the ship are in or proximate a designated sortation area and thus designate those containers as the final destination containers. Various other techniques or combinations thereof may be performed to determine and designate the final destination containers. Similar to block 704, the control system can designate the final destination containers by processing the ship information using trained algorithms, machine learning models, and/or AI.

In block 708, the control system can determine picking operations for the inventory in the first container based on the manifest and the ship information. The control system can apply trained algorithms, machine learning models, and/or AI to determine an order to remove the inventory from the first container. This picking order can be based on an order that the inventory would be loaded into its designated final destination container. The picking order can be based on a size of the inventory and/or an obstruction that the inventory causes to be able to pick other inventory in the first container for their respective final destination containers. When the inventory is picked from the first container, it can sometimes be moved to a buffer area, then later retrieved from the buffer area when ready to be packed into its respective final destination container. Other times, when the inventory is picked, it can be routed directly to its final destination container for sorting and packing. As described herein, in some implementations, the inventory can be picked according to customer orders and types of the customer orders (e.g., direct to customer, online order).

The control system can also determine packing operations for the inventory for each designated container based on the manifest and the carrier information (block 710). Similar to determining the picking operations, the control system can apply trained models, machine learning, and/or AI to determine an order for packing the inventory into each designated final destination container. The inventory can be packed into the designated container based on size, weight capacity, order of display/location at the final destination (e.g., order of display/location in a store or distribution center). In some implementations, the inventory can be packed based on the customer orders and/or type of customer orders (e.g., direct to customer, online order). The inventory can additionally or alternatively be packed based on destination specific information (e.g., group all customer packages going to a particular zip code and/or a particular state), and/or inventory information (e.g., fabrics can be packed separately from other goods, such as food products and/or electronics).

In some implementations, the control system can determine the picking and the packing operations simultaneously/in parallel. As a result, determinations about the packing operations can be fed into determinations about the picking operations and vice versa. Sometimes, the packing operations can be determined before the picking operations, and the picking operations can be determined based on the packing operations. The control system may optionally dynamically update the packing operations based on the determined picking operations.

The control system can generate instructions for sorting the inventory into each designated container based on the picking and packing operations in block 712. Optionally, the control system may generate instructions for moving the inventory to and/or from the buffer area onboard the ship (block 714). The buffer area can also be used as a waiting area, where products can wait to be joined with other products going to a same destination in the buffer area. Then the products in the buffer area can be sequenced and loaded onto a designated destination container. The instructions can sometimes include removing all inventory from a container that is to be a designated container, then loading inventory from other containers into the designated container. As another example, the instructions can include removing a portion of the inventory from the container that does not have the common destination, designating that container as the designated container, and then loading inventory into the designated container from other containers on the ship having the common destination. If an already-empty container is designated as the designated container, then the instructions may include sequencing for picking and packing inventory from other containers into the designated container. Various other instructions may also be generated as described herein.

Optionally, the control system can return the instructions to devices of workers to manually or semi-automatically perform the sorting (block 716). For example, workers onboard the ship may handpick some of the inventory (e.g., fragile, small, lightweight) from containers and put the handpicked inventory on conveyors to designated containers. As another example, workers may break apart boxes or cases of inventory that have been removed from the containers (e.g., the first container) and load them onto the conveyors to be moved to the designated containers. As yet another example, the workers can scan labels or other unique identifiers for inventory that are unloaded from the first container, moved to the buffer area, loaded into the respective designated containers, etc. Various other instructions may also be generated based on the disclosure.

In block 718, the control system can execute the instructions to control automated machines on board the ship to perform the sorting. For example, the control system can execute instructions to pick the inventory from the first container according to the picking operations (block 720). The instructions can be executed to control robots, automated machines, sorter systems, and/or conveyors to pick the inventory.

As another example, the control system can optionally execute instructions to route the picked inventory from the first container to the buffer area (block 722). The instructions can be executed to control conveyors, such as automated conveyors and/or high-speed conveyors.

The control system can optionally execute instructions to route the picked inventory from the buffer area to a sortation area (block 724). The instructions can be executed to control conveyors, such as automated conveyors and/or high-speed conveyors.

As another example, the control system can execute instructions to route the picked inventory to the sortation area 726. The instructions can be executed to control conveyors, such as automated conveyors and/or high-speed conveyors.

The control system can additionally or alternatively execute instructions to pack the inventory into the designated container(s) according to the packing operations (block 728). The instructions can be executed to control robots, automated machines, sorter systems, and/or conveyors to perform the packing operations.

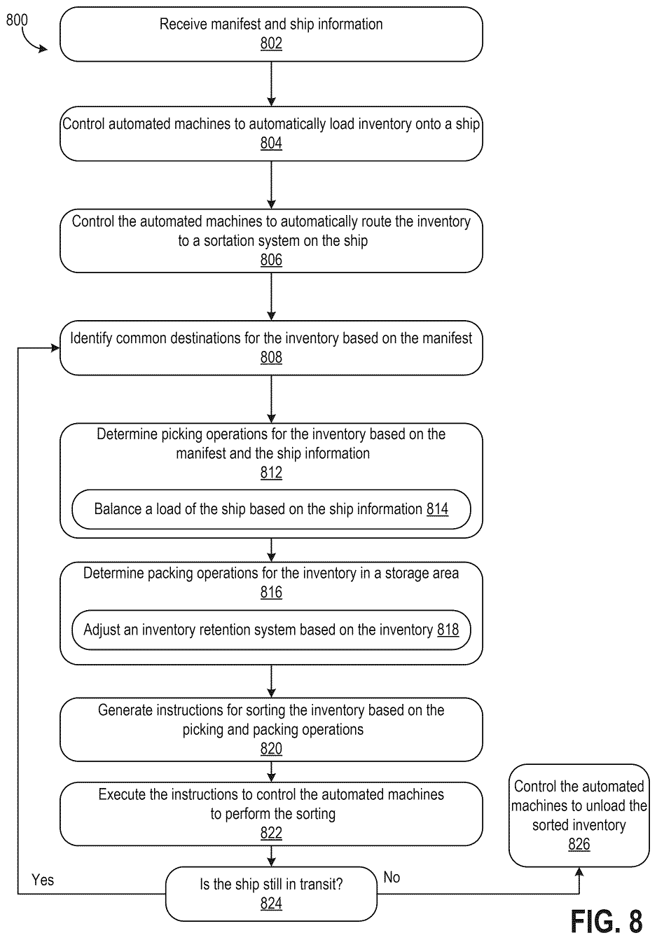

FIG. 8 is a flowchart of a process 800 for automatically sorting inventory onboard a ship in transit. The process 800 can leverage an advanced, automated sorting system on the ship with high-speed conveyors, automated conveyors, and/or automated sorters. In the process 800, inventory can be loaded onto the ship using high-speed conveyors and placed into an intelligent automated sorter. During the trip, the process 800 can leverage learned/trained algorithms, machine learning, and/or AI to intelligently sequence, slot, and/or sort the inventory based on their final destinations. The process 800 can further include balancing such determinations with the ship's load distribution to ensure that operations are performed efficiently and without compromising the ship's load, infrastructure, and/or timely and safe arrival at a destination port. Upon arrival at the destination port, the sorted inventory can be unloaded from the ship in the sequence based on their final destinations, then directly loaded into trailers, containers, or other freight carriers destined for the final destinations. The process 800 can advantageously eliminate manual sorting operations, speed up an unloading process to enable faster delivery to final destinations, optimize space and weight distribution across the ship for overall safety and efficiency, and allow for direct and automated integration with port and/or warehouse operations.

The process 800 can be performed by components of the control system 602 that are described in reference to at least FIG. 6. The process 800 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 800 is described from the perspective of a control system.

Referring to the process 800 in FIG. 8, the control system can receive a manifest and ship information in block 802. Refer to block 702 in the process 700 of FIG. 7 for further discussion.

In block 804, the control system can automatically control one or more automated machines to automatically load the inventory onto the ship. Refer to FIG. 4 for further discussion.

The control system can also automatically control the automated machine(s) to automatically route the inventory to a sortation system on the ship (block 806). Refer to FIG. 4 for further discussion.

In block 808, the control system can identify common destinations for the inventory based on the manifest. Refer to at least block 704 in the process 700 of FIG. 7 for further discussion.

The control system can also determine picking operations for the inventory based on the manifest and the ship information (block 812). Refer to at least block 708 in the process 700 f FIG. 7 for further discussion about determining pick operations.

The control system can also balance a load of the ship based on the ship information in block 814. Balancing the load of the ship can include determining how to adjust weight/location of the picked/sorted inventory on the ship to avoid offsetting weight distribution on the ship. Balancing the load of the ship, as another example, can include determining how and when to use energy (e.g., from the ship's propulsion system) to operate any one or more of the equipment, components, and/or automated machines and systems described herein in light of energy consumption or storage constraints, weather conditions, and/or other energy/power-related constraints/factors. Balancing the load of the ship can also include determining when to perform operations in light of weather conditions and other travel conditions.

The control system can determine packing operations for the inventory in a storage area in block 816. The control system can determine how to arrange the inventory in the storage area. The arrangement can be based on order of loading the inventory into freight carriers at the port for their final destination(s). The arrangement can be based on an order that the inventory will be displayed/presented in a retail environment, store, or other final destination. Sometimes, the packing operations can be determined as part of determining the picking operations. The packing can be determined and performed based on customer orders and/or types of the customer orders (e.g., direct to customer, online order). The packing can be based on destination information (e.g., based on a particular zip code and/or state). The packing can be based on size, weight, capacity, and/or type of the product (e.g., extra large items, such as carpets, can be packed separately, fabrics can be packed separately).

Additionally, the control system can adjust an inventory retention system based on the inventory (block 818). As described in reference to FIG. 5, the control system can control the inventory retention system to automatically raise or lower relative a height of the inventory in order to maintain the inventory securely in place in the storage area. The inventory retention system can also be used and controlled to securely maintain the inventory in place on conveyors while being moved around the ship, sorted, picked, and/or packed.

In block 820, the control system can generate instructions for sorting the inventory based on the picking and packing operations. Refer to at least block 712 in the process 700 of FIG. 7 for further discussion.

The control system can also execute the instructions to control the automated machines to perform the sorting (block 822). Refer to at least block 718 in the process 700 of FIG. 7 for further discussion. Refer to FIG. 4 for an illustrative example of controlling the automated machines.

In block 824, the control system may determine whether the ship is still in transit. If the ship is still en route, the control system can return to block 808 and iterate through the process 800 for all remaining inventory on the ship.

If the ship has arrived at the destination port in block 824, then the control system can control the automated machines to unload the sorted inventory (block 826). Refer to at least FIG. 4 for further discussion.

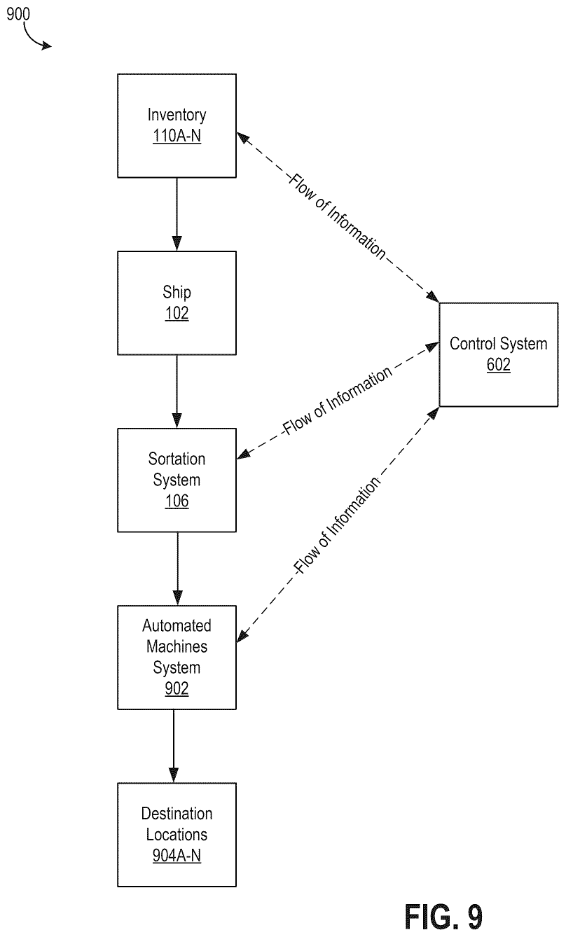

FIG. 9 is a flowchart illustrating a flow 900 of inventory 110A-N and information using the disclosed techniques. The inventory 110A-N can be routed onto the ship 102 and through the sortation system 106 described herein. An automated machines system 902 can be configured to route the inventory 110A-N from the sortation system 106 into destination locations 904A-N on the ship 102. The automated machines system 902 can include any of the automated conveyors, robots, automated machines, etc. described herein. The destination locations 904A-N can include containers that are designated for final destinations (as described in reference to at least FIGS. 3 and 7 in the semi-automated implementation) and/or storage locations in the ship 102 (as described in reference to at least FIGS. 4 and 8 in the automated implementation).

Similarly, information can flow to and from the control system 602 with the inventory 110A-N, the sortation system 106, and/or the automated machines system 902. The information can include instructions generated by the control system 602 based on determining picking and/or packing operations of the inventory 110A-N onboard the ship 102. Such instructions can be executed to control the sortation system 106 and/or the automated machines system 902 accordingly.

In some implementations, information may also flow from one or more of the inventory 110A-N, the sortation system 106, and/or the automated machines system 902. For example, labels or other identifiers associated with the inventory 110A-N can be scanned and provided to the control system 602 for use in determining and/or tracking location/movement of the inventory 110A-N. As another example, the sortation system 106 can send indications back to the control system 602 indicating progress in completing assigned/executed picking/packing operations. The sortation system 106 may scan the labels of the inventory 110A-N as well, which can be transmitted back to the control system 602 as described above. Similarly, the labels of the inventory 110A-N can be scanned by scanning devices or other components that are part of the automated machines system 902 and/or proximate the system 902. The system 902 may additionally or alternatively provide status updates or other information/notifications back to the control system 602 for purposes of tracking the inventory 110A-N throughout the supply chain, modifying picking/packing operations, and/or otherwise adjusting operations and/or energy usage on the ship 102 while the ship 102 is in transit.

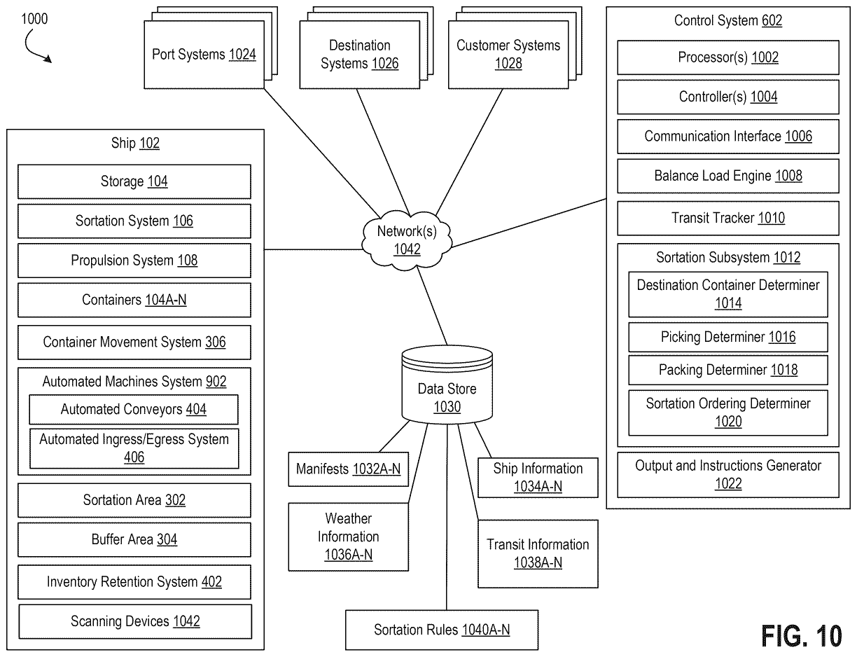

FIG. 10 is a diagram of a system 1000 illustrating components that can be used to perform the disclosed techniques. The system 1000 can include the ship 102, the control system 602, port systems 1024, destination systems 1026, customer systems 1028, and/or a data store 1030 that can be in communication (e.g., wired, wireless, BLUETOOTH, satellite, WIFI) via network(s) 1042. Any of the components described in the system 1000 can be part of a same system and/or separate. For example, the control system 602 can be part of or otherwise on the ship 102. As another example, the data store 1030 can be part of the control system 602. Other combinations of the system components are also possible.

In brief, the port systems 1024 can include processors and memory storing instructions that are executable by the processors. Accordingly, the port systems 1024 can be configured to maintain, collect, and/or provide information about the ship 102, other ships, inventory, weather conditions, port availability, dock availability, port and/or dock scheduling, destination information, container information, etc. In some implementations, for example, the port systems 1024 can provide the control system 602 with information such as manifests 1032A-N, weather information 1036A-N, ship information 1034A-N, and/or transit information 1038A-N, all of which may be used by the control system 602 to determine sortation operations for the ship 102 whilst in transit.

The destination systems 1026 can include processors and memory storing instructions that are executable by the processors. Accordingly, the systems 1026 can be configured to provide, generate, and/or maintain information about destinations, such as distribution centers and/or retail environments or stores. Such information can include, as examples, a map of a retail store, indications of where different products/inventory may be laid out in the distribution centers and/or retail environments or stores, required or requested quantities of the products/inventory, current or near real-time stock levels of the products/inventory in the distribution centers and/or retail environments or stores, seasonal information about the products/inventory, current, expected, and/or historic demand for the products/inventory, current live online orders of customers, etc. This information can be provided to the control system 602 for use in determining sortation operations for the ship 102 whilst in transit.

The customer systems 1028 can include processors and memory storing instructions that are executable by the processors. Accordingly, the customer systems 1028 can be configured to provide, generate, and/or maintain information about their products/inventory. Such information can include, as examples, product type, product storage temperature, product storage constraints or other requirements, height, size, weight constraints, product/inventory quantities, customer requirements, hazard class items (e.g., flammable items, batteries, corrosive materials), etc. This information can be provided to the control system 602 as the manifests 1032A-N or as other information for use in determining sortation operations for the ship 102 whilst in transit.

As described herein, the ship 102 can include components such as the storage 104, the sortation system 106, the propulsion system 108, the containers 104A-N, the container movement system 306, the automated machines system 902 including the automated conveyors 404 and/or the automated ingress/egress system 406, the sortation area 302, the buffer area 304, the inventory retention system 402, scanning devices 1042, and/or any combination thereof. The components onboard the ship 102 may also vary based on the ship and/or the implementation chosen for the ship 102. For example, if the semi-automated implementation described herein is used, the ship 102 can include the containers 104A-N and the container movement system 306. As another example, if the automated implementation described herein is used, the ship 102 may not include the containers 104A-N and instead would include the automated conveyors 404, the automated ingress/egress system 406, and the inventory retention system 402.

The control system 602 can include processor(s) 1002, controller(s) 1004, a communication interface 1006, a balance load engine 1008, a transit tracker 1010, a sortation subsystem 1012, and/or output and an instructions generator 1022.

The processor(s) 1002 can be configured to execute instructions stored in memory (not depicted) to perform the disclosed techniques of determining sorting operations for the ship 102 whilst in transit. The communication interface 1006 can be configured to provide communication between components of the control system 602 and other components described in the system 1000.

The controller(s) 1004 can be configured to execute instructions that are determined by the control system 602 in order to control and operate the components of the ship 102, such as the sortation system 106, the propulsion system 108, the container movement system 306, the automated machines system 902, and/or the inventory retention system 402. Sometimes, the control system 602 can include a controller 1004 for each of the components of the ship 102.

The balance load engine 1008 can be configured to receive the ship information 1034A-N (e.g., from the data store 1030), the weather information 1036A-N, and/or the transit information 1038A-N and use such information to determine whether the load/weight of the ship 102 is properly balanced amidst sorting operations being performed on the ship 102. The engine 1008 can determine, for example, when to pause sorting operations due to inclement weather and/or when to shift one or more sorting operations based on availability of energy from the propulsion system 108 and/or uneven distribution of weight across the ship 102.

The transit tracker 1010 can be configured to receive information such as the weather information 1036A-N, the ship information 1034A-N, and/or the transit information 1038A-N, then process said information to track the ship 102 whilst in transit to its destination port. The ship tracking can be beneficial to determine and/or adjust the sorting operations onboard the ship 102 to ensure that the sorting operations are completed before the ship 102 arrives at the destination port.

In some implementations, the transit tracker 1010 may be configured to track movement of the inventory onboard the ship 102. For example, the scanning devices 1042 described herein can be positioned throughout the ship 102, in the storage 104, the sortation system 106, the containers 104A-N, the container movement system 306, the automated machines system 902, the sortation area 302, the buffer area 304, and/or the inventory retention system 402. The scanning devices 1042 can capture scans of the inventory and/or labels/identifiers associated with the inventory. The captured scans can be transmitted to the transit tracker 1010 and used by the tracker 1010 to determine where the inventory is currently located, where the inventory is going, and/or how quickly the sortation operations associated with the inventory is being performed.

The sortation subsystem 1012 can be configured to determine sortation operations (e.g., picking, packing) for the inventory onboard the ship 102 in transit. The sortation subsystem 1012 can include, for example, a destination container determiner 1014, a picking determiner 1016, a packing determiner 1018, and/or a sortation ordering determiner 1020.

The destination container determiner 1014 can implemented with the semi-automated implementation described herein. The destination container determiner 1014 can be configured to process information such as the manifests 1032A-N and the ship information 1034A-N to identify common destinations across the inventory in the containers 104A-N and then identify and designate one or more of the containers 104A-N as containers for the identified common destinations.

The picking determiner 1016 can be configured to process information such as the manifests 1032A-N, the ship information 1034A-N, and/or one or more sortation rules 1040A-N to determine orders of picking, whilst in transit, the inventory (e.g., from the containers 104A-N in the semi-automated implementation) for sortation based on final destinations and/or product types.

The packing determiner 1018 can be configured to process information such as the manifests 1032A-N, the ship information 1034A-N, and/or the sortation rules 1040A-N to determine orders of packing, whilst in transit, the inventory into the designated final destination containers (e.g., in the semi-automated implementation) and/or the storage 104 (e.g., in the automated implementation) based on final destinations and/or product types.

The sortation ordering determiner 1020 can be configured to process information such as the manifests 1032A-N, the ship information 1034A-N, the sortation rules 1040A-N, the picking operations, the packing operations, and/or the balance load determinations to determine an order for sorting the inventory into the designated final destination containers (e.g., in the semi-automated implementation) and/or the storage 104 (e.g., in the automated implementation) based on final destinations and/or product types. The determiner 1020 can be configured to consolidate and/or synthesize the information and/or determinations made by the other components of the control system 602. The determiner 1020 may also be configured to determine the order of sorting the inventory based on information received from the port systems 1024, the destination systems 1026, and/or the customer systems 1028.

The output and instructions generator 1022 can be configured to receive the determinations made by the sortation subsystem 1012 and generate instructions accordingly. Those instructions can then be transmitted to the controller(s) 1004 for automatic execution and control of the ship 102 components. The generator 1022 may also generate information to be presented at computing devices and/or user devices of relevant stakeholders, such as workers onboard the ship 102, users at the ports, users at the destinations, and/or customers.

The data store 1030 can include a database, data lake, and/or cloud-based storage system. The data store 1030 can be configured to maintain information described herein, including but not limited to the manifests 1032A-N, the ship information 1034A-N, the weather information 1036A-N, the transit information 1038A-N, and/or the sortation rules 1040A-N. The information can be accessed from the data store 1030 by components of the control system 602 to perform the operations described herein. In some implementations, the sortation operations, picking/packing operations, other operations, instructions, and/or outputs that are determined by the control system 602 can be maintained in the data store 1030.

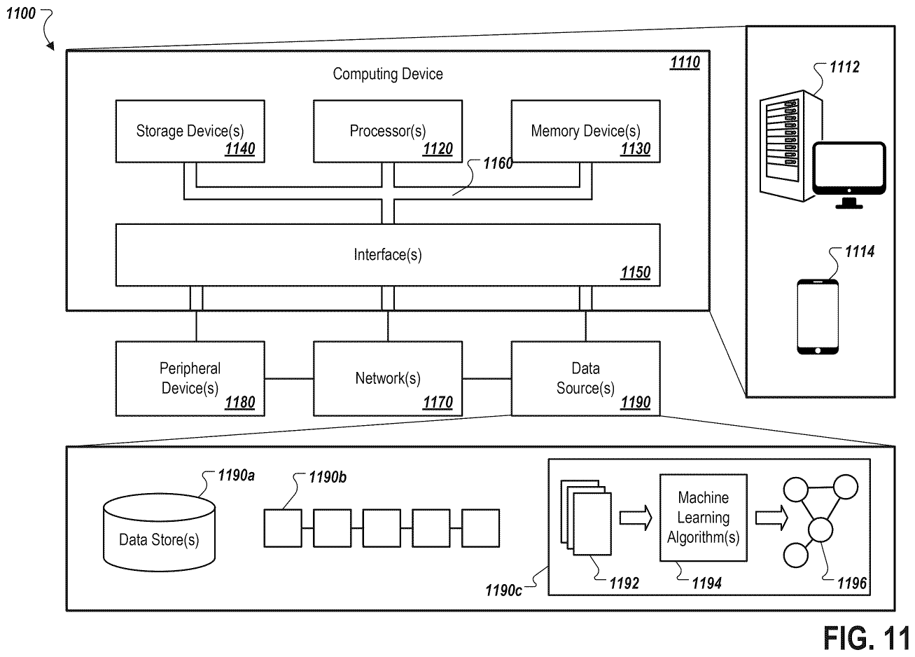

FIG. 11 is a schematic diagram that shows an example of a computing system 1100 that can be used to implement the techniques described herein. The computing system 1100 includes one or more computing devices (e.g., computing device 1110), which can be in wired and/or wireless communication with various peripheral device(s) 1180, data source(s) 1190, and/or other computing devices (e.g., over network(s) 1170). The computing device 1110 can represent various forms of stationary computers 1112 (e.g., workstations, kiosks, servers, mainframes, edge computing devices, quantum computers, etc.) and mobile computers 1114 (e.g., laptops, tablets, mobile phones, personal digital assistants, wearable devices, etc.). In some implementations, the computing device 1110 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1110, and an entire system can be made up of multiple devices communicating with each other. For example, the computing device 1110 can be part of a computing system that includes a network of computing devices, such as a cloud-based computing system, a computing system in an internal network, or a computing system in another sort of shared network. Processors of the computing device (1110) and other computing devices of a computing system can be optimized for different types of operations, secure computing tasks, etc. The components shown herein, and their functions, are meant to be examples, and are not meant to limit implementations of the technology described and/or claimed in this document.

The computing device 1110 includes processor(s) 1120, memory device(s) 1130, storage device(s) 1140, and interface(s) 1150. Each of the processor(s) 1120, the memory device(s) 1130, the storage device(s) 1140, and the interface(s) 1150 are interconnected using a system bus 1160. The processor(s) 1120 are capable of processing instructions for execution within the computing device 1110, and can include one or more single-threaded and/or multi-threaded processors. The processor(s) 1120 are capable of processing instructions stored in the memory device(s) 1130 and/or on the storage device(s) 1140. The memory device(s) 1130 can store data within the computing device 1110, and can include one or more computer-readable media, volatile memory units, and/or non-volatile memory units. The storage device(s) 1140 can provide mass storage for the computing device 1110, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1150 can include various communications interfaces (e.g., USB, Near-Field Communication (NFC), Bluetooth, WiFi, Ethernet, wireless Ethernet, etc.) that can be coupled to the network(s) 1170, peripheral device(s) 1180, and/or data source(s) 1190 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1150 can include a control interface that receives commands from an input device (e.g., operated by a user) and converts the commands for submission to the processors 1120. The interface(s) 1150 can include a display interface that includes circuitry for driving a display to present visual information to a user. The interface(s) 1150 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1170 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1110 can communicate with the peripheral device(s) 1180, the data source(s) 1190, and/or other computing devices over the network(s) 1170. In some implementations, the computing device 1110 can directly communicate with the peripheral device(s) 1180, the data source(s), and/or other computing devices.

The peripheral device(s) 1180 can provide input/output operations for the computing device 1110. Input devices (e.g., keyboards, pointing devices, touchscreens, microphones, cameras, scanners, sensors, etc.) can provide input to the computing device 1110 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1110 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1190 can provide data for use by the computing device 1110, and/or can maintain data that has been generated by the computing device 1110 and/or other devices (e.g., data collected from sensor devices, data aggregated from various different data repositories, etc.). In some implementations, one or more data sources can be hosted by the computing device 1110 (e.g., using the storage device(s) 1140). In some implementations, one or more data sources can be hosted by a different computing device. Data can be provided by the data source(s) 1190 in response to a request for data from the computing device 1110 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1190a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1190b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1190c. The machine learning system(s) 1190c, for example, can be used to analyze data from various sources (e.g., data provided by the computing device 1110, data from the data store(s) 1190a, data from the blockchain(s) 1190b, and/or data from other data sources), to identify patterns in the data, and to draw inferences from the data patterns. In general, training data 1192 can be provided to one or more machine learning algorithms 1194, and the machine learning algorithm(s) can generate a machine learning model 1196. Execution of the machine learning algorithm(s) can be performed by the computing device 1110, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A ship configured for in-transit inventory sortation, the ship comprising:
a storage area configured to maintain a first plurality of containers having unsorted inventory;
a sortation area configured to maintain a second plurality of containers having sorted inventory;
a container movement system configured to move, while the ship is in transit, the unsorted inventory from the storage area to the sortation area; and
a sortation system configured to sort, while the ship is in transit, the unsorted inventory based on one or more sorting criteria and move the sorted inventory into the second plurality of containers that satisfy the one or more sorting criteria.

2. The ship of claim 1, wherein the second plurality of containers are each designated for a final destination.

3. The ship of claim 1, wherein the one or more sorting criteria comprises a final destination of the sorted inventory.

4. The ship of claim 1, wherein the one or more sorting criteria comprises a product type of the sorted inventory.

5. The ship of claim 1, wherein the container movement system is configured to move a portion of the unsorted inventory from the first plurality of containers to the sortation area based on the portion of the unsorted inventory satisfying the one or more sorting criteria.

6. The ship of claim 1, wherein the ship further comprises a propulsion system that is configured to power the container movement system and the sortation system while the ship is in transit.

7. The ship of claim 1, wherein the container movement system comprises automated or semi-automated conveyors.

8. The ship of claim 1, wherein the container movement system comprises a fleet of robots or automated machines.

9. A ship configured for automated in-transit inventory sortation, the ship comprising:
a storage area configured to maintain inventory;
a sortation system configured to sort, while the ship is in transit, the inventory based on one or more sorting criteria and move the sorted inventory into storage locations in the storage area that satisfy the one or more sorting criteria; and
automated conveyors configured to move the inventory in the ship based on the sorting performed by the sortation system.

10. The ship of claim 9, wherein the ship further comprises an inventory retention system configured to automatically adjust to a size of each of the inventory to securely maintain each of the inventory in place while the ship is moving or while each of the inventory is moving in the ship.

11. The ship of claim 9, wherein the automated conveyors comprise high-speed conveyors.

12. The ship of claim 9, wherein the ship further comprises an automated ingress/egress system configured to move the inventory from containers at a port into the storage area of the ship before the ship leaves the port.

13. The ship of claim 9, wherein the ship comprises a control system configured to:
control automated machines to automatically load the inventory onto the ship at a port;
control the automated machines to automatically move the inventory to the sortation system onboard the ship;
identify common destinations for the inventory based on a manifest for the inventory;
determine sorting operations for sorting the inventory, by the sortation system, based on the common destinations for the inventory; and
execute instructions to cause the sortation system to perform the sorting operations while the ship is in transit.

14. The ship of claim 13, wherein determining the sorting operations is further based on balancing a load of the ship while the ship is in transit.

15. The ship of claim 13, wherein determining the sorting operations comprises:
determining picking operations of the inventory;
determining packing operations of the inventory; and
generating instructions to adjust an inventory retention system based on a size of the inventory being picked and packed.

16. A system for inventory sortation on a ship in transit, the system comprising:
a storage area configured to maintain inventory;
a sortation system configured to sort, while the ship is in transit, the inventory based on one or more sorting criteria; and
conveyors configured to move the inventory in the ship based on the sorting performed by the sortation system.

17. The system of claim 16, wherein the one or more sorting criteria comprises final destinations of the inventory, and the storage locations comprise containers that are designated for the final destinations of the inventory.

18. The system of claim 16, wherein the storage locations comprise locations in the storage area that are designated for final destinations of the inventory.

19. The system of claim 16, wherein the sortation system comprises automated machines.

20. The system of claim 16, wherein the system further comprises a control system configured to, while the ship is in transit:
receive a manifest for the inventory onboard the ship;
determine common destinations for the inventory based on the manifest;
determine sorting operations, for execution by the sortation system, to sort the inventory based on the common destinations; and
return the sorting operations for automatic execution by the sortation system.
